(19) United States
(12) Patent Application Publication
(10) Pub. No.: US 2015/0066928 A1
(43) Pub. Date: Mar. 5, 2015

(54) ASSOCIATED-DATA PROCESSOR, ASSOCIATED-DATA PROCESSING METHOD AND INFORMATION STORAGE MEDIUM

(71) Applicant: KABUSHIKI KAISHA TOSHIBA, Tokyo (JP)

(72) Inventors: Hideo Kataoka, Tokyo (JP); Yuki Kaneko, Kawasaki-shi (JP); Sougo Tsuboi, Kawasaki-shi (JP); Hideo Kezuka, Fuchu-shi (JP); Hideyuki Toma, Kodaira-shi (JP)

(73) Assignee: KABUSHIKI KAISHA TOSHIBA, Tokyo (JP)

(21) Appl. No.: 14/203,117

(22) Filed: Mar. 10, 2014

(30) Foreign Application Priority Data
Sep. 4, 2013 (JP) 2013-182907

(51) Int. Cl. G06F 17/30

(52) U.S. Cl. CPC G06F 17/30044
USPC 707/737

(57) ABSTRACT

According to one embodiment of the present disclosure, a first data file, a second data file, a third data file and a file controlling logic portion are provided. In the first data file, basic data of a plurality of programs are stored. The basic data indicates a plurality of attributes related to each program. The second data file associates viewers with a plurality of programs. The third data file associates programs with a plurality of viewers. The file controlling logic portion is configured to access the first to third data files, generate a cluster in which data is associated depending on a theme and specify a viewer and/or a program included in the cluster.

### CROSS-REFERENCE TO RELATED APPLICATIONS

This application is based upon and claims the benefit of priority from Japanese Patent Application No. 2013-182907, filed Sep. 4, 2013, the entire contents of which are incorporated herein by reference.

### FIELD

Embodiments described herein relate generally to an associated-data processor, an associated-data processing method and an information storage medium.

### BACKGROUND

Recently, the Internet service business has become vigorous. In the Internet service industry, information is exchanged in the communication environment between a server on the Internet and a personal computer and/or a mobile device (a cellular phone, a tablet computer, a personal digital assistant [PDA] device, etc.).

In recent years, digital television receivers have also become connectable to the Internet. Therefore, there is demand to use television receivers as well as mobile devices and personal computers in the communication with a server.

Digital television receivers used at home have the advantage of a large and clear monitor screen compared with other devices which can display images, such as personal computers, cellular phones and tablet computers. Most importantly, digital television receivers have gained popularity, and have a feature of delivering information to a large audience.

On the other hand, compact personal computers, cellular phones and tablet computers, etc., have the merit of portability. In addition, personal computers and tablet computers are excellent in operability for inputting data.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 illustrates an example of a basic structure of a communication system to which one embodiment is applied.

FIG. 2A illustrates an example of a data file constructed in a service server 4001, and shows that basic data exists in a program.

FIG. 2B illustrates an example of a data file constructed in the service server 4001, and shows a relationship between a program and a viewer who viewed the program.

FIG. 2C illustrates an example of a data file constructed in the service server 4001, and shows a relationship between a viewer and a program viewed by the viewer.

FIG. 2D illustrates an example of a data file constructed in the service server 4001, and shows a viewer address used when the service server communicates with a viewer.

FIG. 3 illustrates an example of a data file constructed in the service server 4001, and specifically shows basic data of a program.

FIG. 4 is shown in order to explain an example of a case where a program is associated with a viewer, and a viewer is associated with another viewer.

FIG. 5 is shown in order to explain an example of a case where a program is associated with another program in the service server 4001.

FIG. 6 is a block diagram shown in order to explain a behavior example in the service server 4001.

FIG. 7 illustrates an example of inquiry data displayed in a DTV 1001 when one embodiment is used.

FIG. 8 is a flowchart shown in order to explain another behavior example in one embodiment.

FIG. 9 is a block diagram shown in order to explain a behavior example in one embodiment.

FIG. 10 is a block diagram shown in order to explain another behavior example in one embodiment.

FIG. 11 illustrates an overview of a remote controller and the DTV in one embodiment.

FIG. 12 illustrates a state at which the DTV in one embodiment is connected to a cloud service server and an initial menu screen is displayed.

FIG. 13 illustrates a display state of a screen 100 when the DTV in one embodiment is connected to the cloud service server via a network and logins with a personal ID.

FIG. 14 illustrates a case where the DTV in one embodiment is used on the network.

FIG. 15 illustrates an organization example of each server forming the time cloud service server 4001 in one embodiment.

FIG. 16 illustrates a structural example of an information processor and a DTV function block together with a mutual relationship in the DTV in one embodiment.

FIG. 17 is a flowchart shown in order to explain another behavior example within a file controlling logic portion 4003 related to one embodiment.

FIG. 18 is a flowchart shown in order to explain another behavior example within the file controlling logic portion 4003 related to one embodiment.

### DETAILED DESCRIPTION

Various embodiments will be described hereinafter with reference to the accompany drawings.

In general, according to one embodiment, an associated-data processor, an associated-data processing method and an information storage medium can efficiently use a digital television receiver for collecting various types of items of data, and apply the usability to a broad range of fields.

According to an embodiment of the present disclosure, a data file and a file controlling logic portion are provided. The data file includes basic data of a plurality of programs, data of a plurality of programs each associated with viewers, data of a plurality of viewers each associated with programs. The basic data indicates attributes related to each program. The file controlling logic portion is configured to access at least the data file, generate a data cluster based on a theme, and specify a viewer or a program included in the data cluster.

An embodiment will further be described with reference to the drawings.

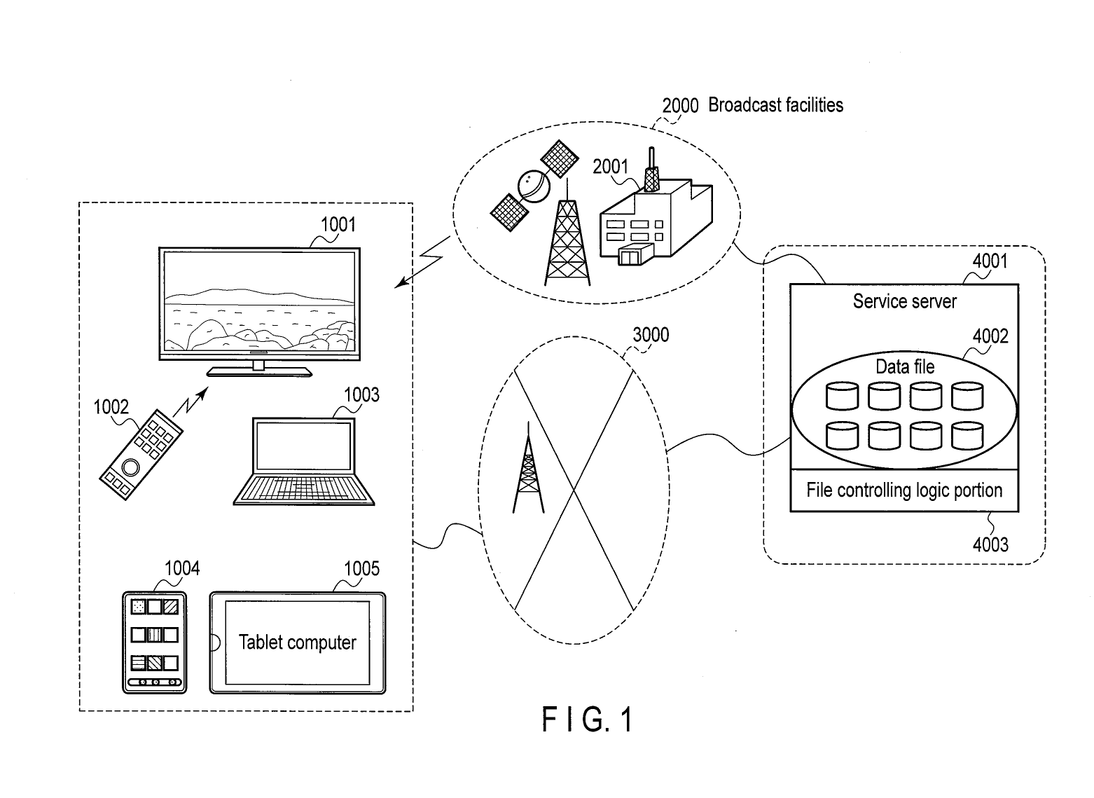

FIG. 1 shows a user device group 1000. This group includes, for example, a digital television receiver (DTV) 1001, a remote controller 1002, a mobile device (personal computer) 1003, a mobile device (a feature phone or a smartphone) 1004 and a mobile device (tablet computer) 1005.

The DTV 1001 can be operated by the remote controller 1002. The DTV 1001 can be also wirelessly operated by the mobile device (which is, for example, a cellular phone or a smartphone, and is hereinafter explained as a cellular phone) 1004. The personal computer 1003 is connectable to a service server 4001 via a network 3000, using or without using a wired line. The cellular phone 1004 and the tablet computer 1005 are wirelessly connectable to the service server 4001 via the network 3000. The DTV 1001 is a so-called net TV, and is connectable to the service server 4001 via the network 3000.

The service server 4001 is connected to a broadcast station 2001 included in broadcast facilities 2000, using or without using a wired line. With respect to an arbitrary broadcast program, the broadcast station 2001 can transmit inquiry data requested by the service server 4001 in the same channel as the arbitrary program during the broadcasting hours of the arbitrary program, or during a certain period before or after the broadcasting hours.

Various types and contents are used for inquiry data depending on the theme presented by a requester. As explained later, for example, inquiry data can be used as data for collecting feedback on a program from the audience, information of audience interest in the cast of a program, and information of audience interest in commercial products, etc. A theme can include elements such as “suggestion”, “question”, “investigation”, “questionnaire”, “consultation”, “comments”, “pursuit”, “chase” and “warning”.

The viewers who viewed a program on the DTV 1001 can transmit response data with respect to inquiry data to the service server 4001 via the network 3000.

The terms “inquiry data” and “response data” are not limited to these examples. For example, various terms such as “question”, “answer”, “transmission”, “reception”, “why” and “reason” may be used to refer to the data.

Various techniques can be employed to transmit response data to the service server 4001. For example, a user may operate the remote controller 1002 in order to transmit response data via the DTV 1001 and the network 3000. Furthermore, a user may operate the personal computer 1003, the cellular phone 1004 or the tablet computer 1005 in order to transmit response data via the network 3000.

The address required for transmitting response data may be stored in the DTV 1001, the personal computer 1003, the cellular phone 1004 and the tablet computer 1005 in advance.

Alternatively, in addition to inquiry data, a QR code (registered trademark) including an address to which response data should be sent may be displayed on the screen of the DTV 1001. The cellular phone 1004 and/or the tablet computer 1005 comprising a camera can automatically set a transmission destination (address) for response data by reading the QR code. Naturally, the address of the transmission destination may be manually input to a transmission device by a user.

The service server 4001 comprises various types of data files 4002. A file controlling logic portion 4003 accesses the aforementioned data files and generates a cluster of data associated depending on a theme among the data files. The file controlling logic portion 4003 can specify the viewers or programs included in the cluster.

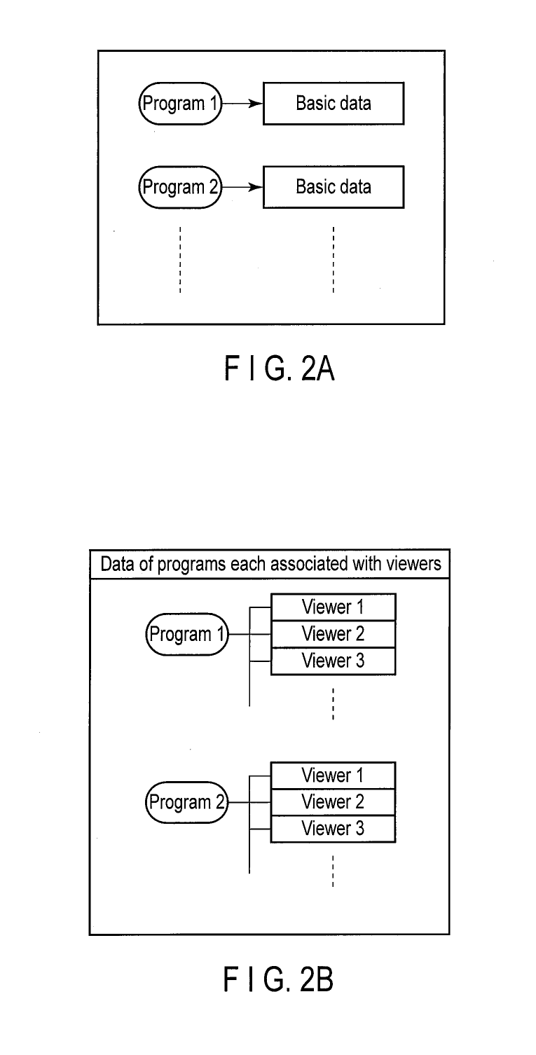

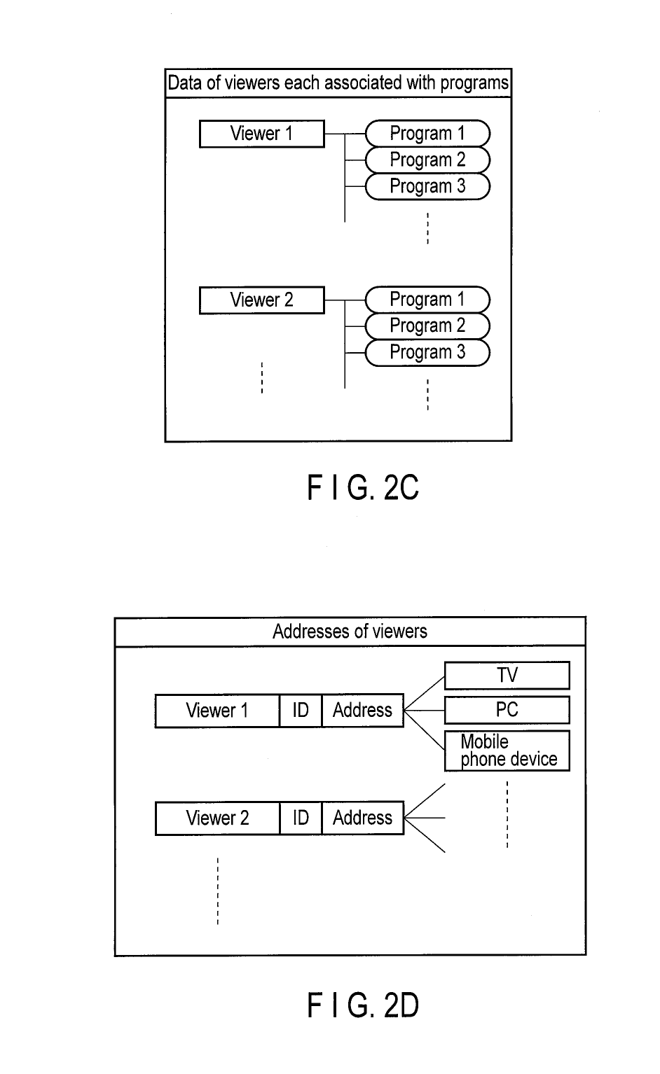

FIG. 2A to FIG. 2D show structural examples of data of various types of data files. FIG. 2A illustrates a file of basic data of each program. FIG. 2A shows that basic data is attached to each program.

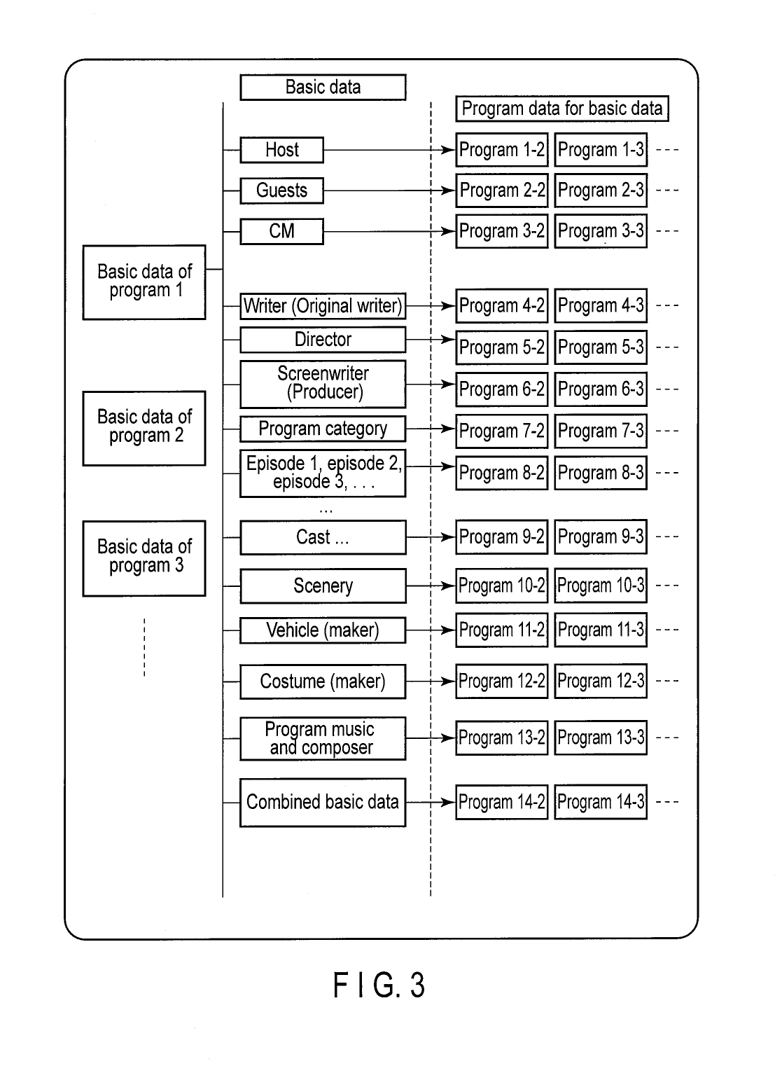

There are basic data attached to program 1 and basic data attached to program 2. Basic data is, for example, the data shown in FIG. 3.

FIG. 3 shows an example of basic data of program 1. Program 1 has a program name unique to the program, a broadcasting channel and a broadcasting time slot, etc. Program 1 further includes the information of the host, guests and commercials (sponsors and products) of program 1, etc. The information of the host, guests and commercial might be changed.

Moreover, there is unchanging data related to basic data of program 1. For example, if program 1 is a drama, unchanging data includes the information of the original writer, the director, the screenwriter and the program category.

In addition to the above, the data includes the information indicating whether program 1 on the air is episode 1 or episode 2, and the information of the cast, the scenery (shooting location), the vehicles appearing in the program (vehicle makers), the costumes of the cast (costume makers), the program music and the composer, etc. Further, there is combined basic data generated by combining one of the above basic data with another.

To this data, the information (program identification information) of another program which has the same basic data may be attached.

Turning to FIG. 2B, FIG. 2B shows a data file of viewers for each program. A list of viewers 11, 12, 13, . . . who viewed program 1 is constructed. Moreover, a list of viewers 21, 22, 23, . . . who viewed program 2 is constructed.

FIG. 2C shows a data file of programs for each viewer. This figure indicates that viewer 1 viewed programs 11, 12 and 13. The figure also shows that viewer 2 viewed programs 21, 22 and 23.

FIG. 2D shows a data file in which the address of each viewer is stored. Each viewer has viewer identification data and an address such as a TV address, a personal computer address and a mobile device address.

FIG. 2A to FIG. 2D and FIG. 3 indicate an example of how to classify and sort out various items of data. However, the classifying and sorting method is not necessarily limited to this system. All files may be integrated into a data file, and among associated data elements, link information may be described in such a way that associated data is linked.

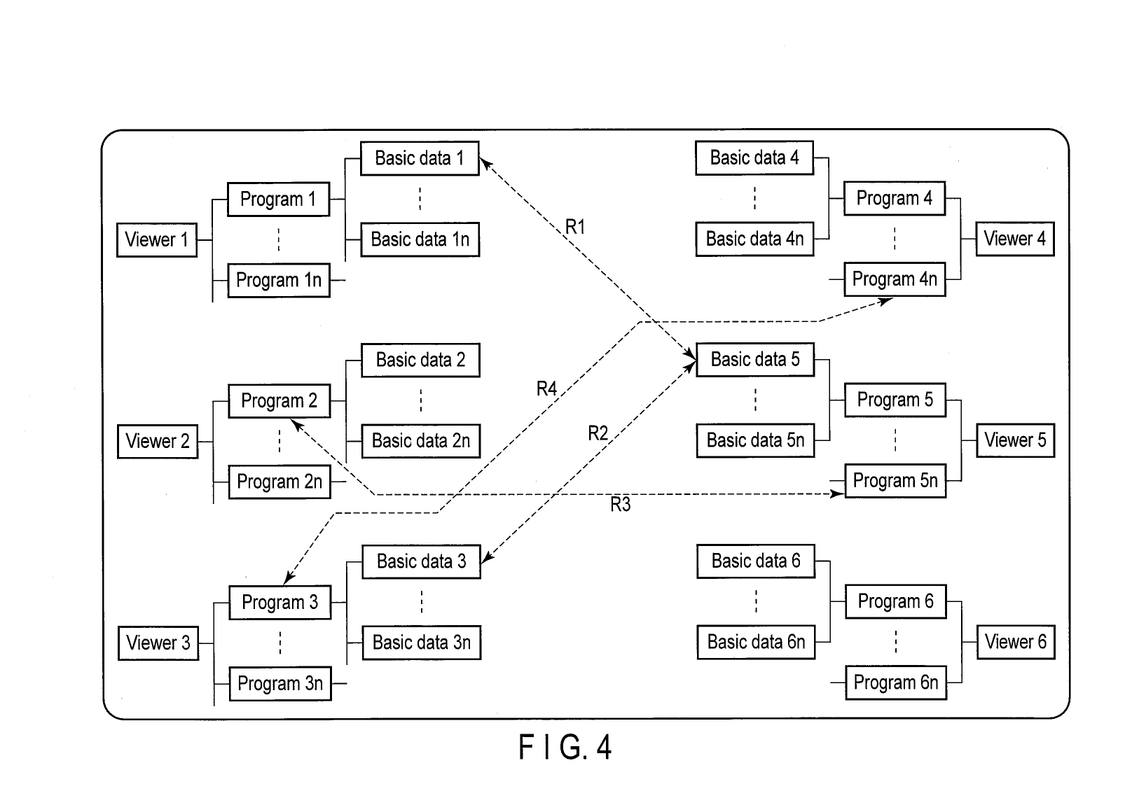

FIG. 4 shows an example of an association route of a case where a viewer is associated with other viewers by the use of the aforementioned data files. Association route R1 shows that a part or all of basic data 1 of program 1 viewed by viewer 1 is the same as a part or all of the basic data of program 5 viewed by viewer 5.

Association route R2 indicates that a part or all of basic data 3 of program 3 viewed by viewer 3 is the same as a part or all of the basic data of program 5 viewed by viewer 5.

Association route R3 shows that program 2 viewed by viewer 2 is the same as program 5n viewed by viewer 5. Association route R4 indicates that program 3 viewed by viewer 3 is the same as program 4n viewed by viewer 4.

These association routes can be searched by an associated data searching device explained later.

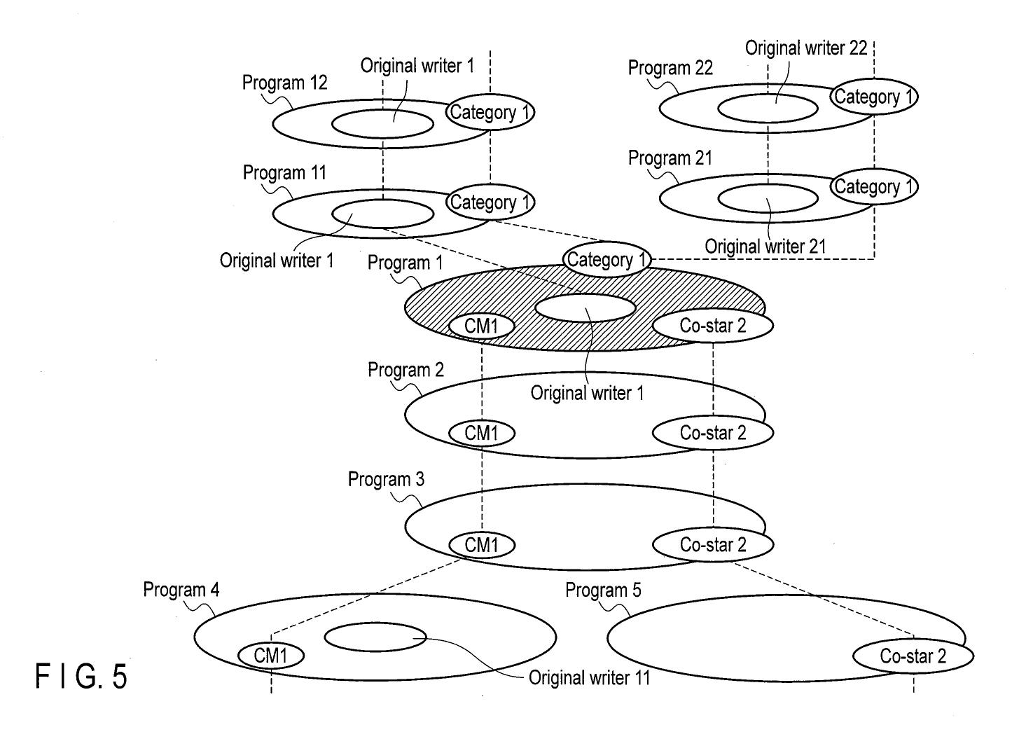

FIG. 5 shows an example of a case where programs are associated with each other. Basic data is attached to each program. Therefore, for example, when CM1 exists as the basic data of program 1, programs 1, 2, 3 and 4 can be associated with each other. This association state may be referred to as an association state based on the axis of CM1, and may be referred to as an association state based on the aspect of CM1.

The example of FIG. 5 further shows an association state based on the axis of co-star 2 who appears in program 1. The example shows that co-star 2 in program 1 also appears in programs 2, 3 and 5.

FIG. 5 also shows an association state based on the axis of combination of original writer 1 with category 1. The figure illustrates that original writer 1 is also the writer of programs 1, 11 and 12 and is the writer of programs which belong to category 1.

An association state based on only the axis of category 1 is shown. This example indicates that programs 21 and 22 belong to category 1 in addition to programs 1, 11 and 12. As shown in the example, the original writer of program 21 is different from the original writer of program 22.

Thus, in this system, programs can be associated with each other based on various types of aspects or axes. Therefore, the use of the above database allows us to obtain association states as follows. Taking a program as the starting point, it is possible to obtain an association state of the program with a program based on a different axis and an association state of the program with a viewer.

In a data file of this system, basic data indicating a plurality of attributes related to a program is defined, and basic data of a plurality of programs is stored (FIG. 2A, FIG. 3). The data file includes data of a plurality of programs each associated with viewers (FIG. 2B) and data of a plurality of viewers each associated with programs (FIG. 2C).

In sum, the file controlling logic portion is configured to access at least the data file, generate a data cluster in which data selected depending on a theme is associated, and specify the viewers or programs included in the data cluster.

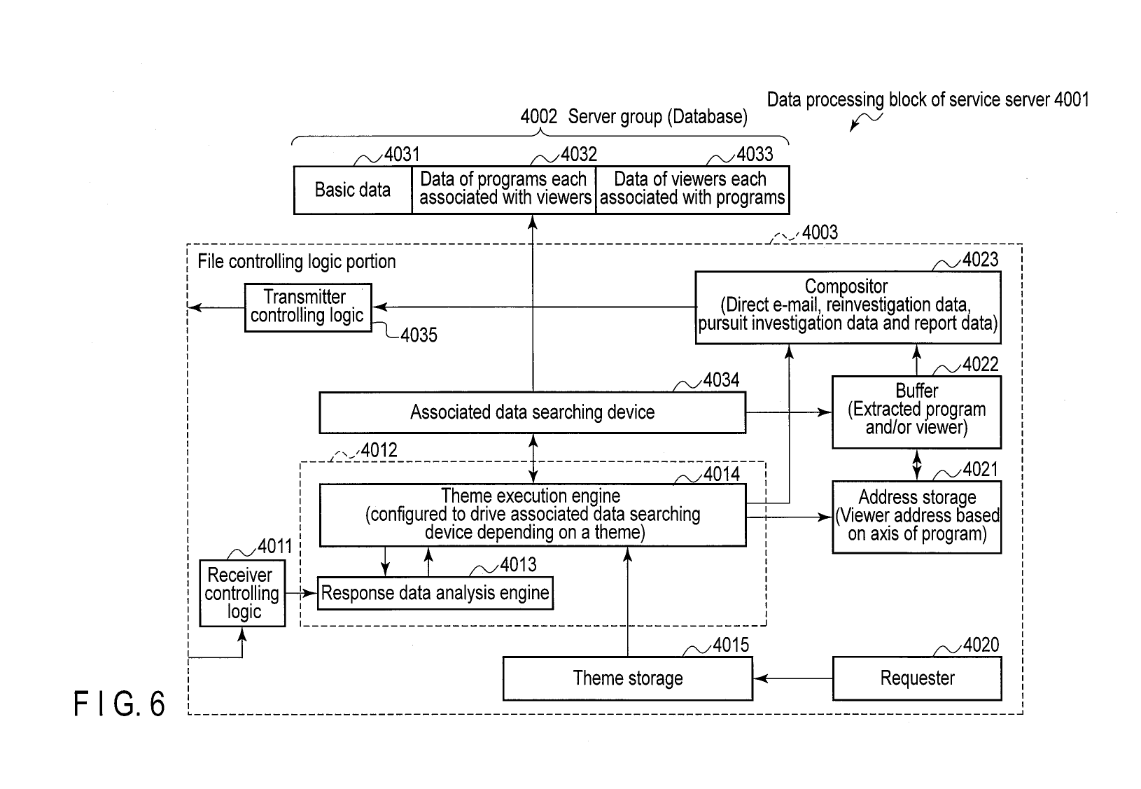

FIG. 6 shows an example of a data processing block in the service server 4001. Receiver controlling logic 4011 receives response data via a network and a receiver. The output of the receiver controlling logic 4011 is input to a response data analysis engine 4013 within a sequencer 4012. The response data analysis engine 4013 analyzes response data sent from a plurality of viewers based on an analytical program. The analytical program analyzes response data in accordance with procedures which are planned depending on the theme requiring the response data. Response data includes identification information of a viewer who transmitted the response data.

Among a plurality of items of response data, the analytical program extracts response data satisfying the desired conditions in line with the predetermined rules. This response data is referred to as, for example, target response data.

As the predetermined rules, various kinds of rules may be determined depending on the purpose (theme) of data analysis.

A theme is determined based on what sort of things a requester 4020 would like to know or do through the program. A theme may include elements such as “suggestion”, “question”, “investigation”, questionnaire”, “consultation”, “comments”, “pursuit” and “chase”.

The identification information of the viewer who transmitted the target response data (this viewer is referred to as, for example, a target viewer) is used in a theme execution engine 4014.

The target viewer and target response data extracted based on the program process are the viewer and response data in which the requester 4020 is interested.

The theme execution engine 4014 drives an associated data searching device 4034. The associated data searching device 4034 is configured to search various types of items of data within a file 4031 of basic data, a file 4032 of data of a plurality of programs each associated with viewers and a file 4033 of data of a plurality of viewers each associated with programs. The files 4031, 4032 and 4033 are included in the data file 4002.

The associated data searching device 4034 may be referred to as an associated data searching module, searching logic and a searching engine, etc.

The theme execution engine 4014 is configured to:

(A) extract another program viewed by a target viewer through the associated data searching device 4034; and/or

(B) extract a new viewer who viewed the above extracted program; and/or

(C) extract another program having common data which is partially common to the basic data related to the program viewed by the target viewer, and extract a new viewer who viewed the program having common data.

In the above extraction process, the associated data searching device 4034 uses the data file (database) explained above.

The theme execution engine 4014 executes a theme purpose based on a program (or software) stored in a theme storage 4015. The program stored in the information storage medium of the theme storage 4015 is offered from the requester 4020.

The requester 4020 is, for example, a program sponsor, a program producer, a broadcast station or a company which desires research of various kinds of markets.

The theme execution engine 4014 is configured to further extract a new program and/or a new viewer from the database. The viewer of the extracted new program and the extracted new viewer are viewers whose replies are expected by a requester. In other words, the requester assumes that these viewers may send target response data in reply to inquiry data.

The data of a new program and/or a new viewer is stored in a buffer 4022 in the meantime. Thus, the file controlling logic portion 4003 is configured to generate a cluster in which data is associated depending on a theme among various types of data files and specify the viewers and/or programs included in the cluster.

The address of a viewer is saved in an address storage 4021. Therefore, the theme execution engine controls a compositor (or composition logic) 4023. Based on this control, the theme execution engine generates combined data. The combined data is generated by attaching comments or reinvestigation data, pursuit investigation data and report data, etc., to the address of a viewer who has viewed the extracted program, or the address of the extracted new viewer.

This combined data may be referred to as expandability inquiry data. This expandability inquiry data is transmitted to a transmitter by transmitter controlling logic 4035.

When inquiry data is broadcast again together with a program, the broadcast station is set as a transmission destination. When inquiry data or reinvestigation data, etc., is distributed by a direct e-mail, for example, the data is transmitted to, directly or via the server of the network 3000, a communication device of a target viewer or a new viewer, such as a personal computer, a cellular phone, an iPhone and a tablet computer.

In the above explanations, combined data is referred to as expandability inquiry data because of the following reasons.

In this system, response data is analyzed. When inquiry data is distributed again or report data or next inquiry data is distributed based on the analysis result, the data is delivered to a new viewer. For example, to the target viewers of the investigation, a new viewer who is different from the target viewers can be added. For example, as the investigation proceeds in series as the first investigation, the second investigation, the third investigation, . . . associated with each other based on a certain theme, the number of target viewers is not decreased. Therefore, this investigation has a feature of expandability.

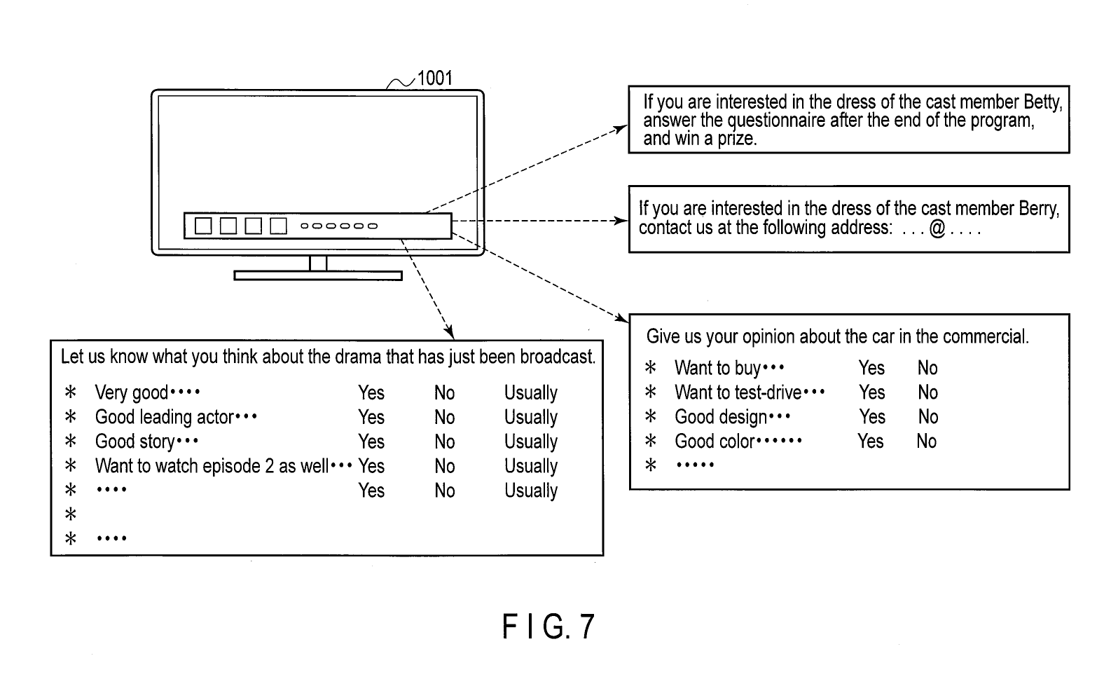

FIG. 7 shows an example of inquiry data which is displayed on the DTV 1001 when the above system is used. For example, during the broadcasting time of a program or during a certain period before or after the broadcasting time, inquiry data is displayed on the screen as inquiry data related to an item or a plurality of items of basic data of the program.

For example, there is a case where a dress maker would like to know the reaction of audience to a new dress. In this case, for example, the following message is displayed on the screen: “If you are interested in the dress of cast member Betty, answer the questionnaire after the end of the program, and win a prize.” or “If you are interested in the dress of the cast member Berry, contact us at the following address: . . . @ . . . ”.

If a viewer sends a reply to the above inquiry, the dress maker can use the target viewer information as information for narrowing down the persons to whom the dress should be promoted or the persons to whom a direct e-mail should be sent.

In the case where a sponsor is an automobile retailer and would like to hear opinions from viewers regarding a newly-designed automobile put on the market, the following questionnaire sheet is displayed on the screen as inquiry data:

Give us your opinion about the car in the commercial.

| | | |
|---|---|---|
| *Want to buy | Yes | No |
| *Want to test-drive | Yes | No |
| *Good design | Yes | No |
| *Good color | Yes | No |
| *. . . | | |

Apart from the above cases, a broadcast station or a production company may want to know opinions regarding the broadcast drama. In this case, the following questionnaire sheet is displayed on the screen as inquiry data:

Let us know what you think about the drama that has just been broadcast.

| | | | |
|---|---|---|---|
| *Very good | Yes | No | Usually |
| *Good leading actor | Yes | No | Usually |
| *Good story | Yes | No | Usually |
| *Want to watch episode 2 as well | Yes | No | Usually |
| *. . . | Yes | No | Usually |
| *. . . | Yes | No | Usually |
| Viewers send replies to the above questionaire | | | |

Various ways can be employed for replying to the questionnaire.

A viewer operates the remote controller 1002 to move the cursor on the screen. By the cursor, the viewer can select the desired button (Yes, No, Usually, etc.) and press the confirm button.

The viewer may respond to the above questionnaire by operating the personal computer 1003, the cellular phone 1004 and the tablet computer 1005, etc.

The cellular phone 1004, the tablet computer 1005 and the personal computer 1003, etc., are also configured to request an operation screen from the DTV 1001 by the use of a short-range wireless system. When the DTV 1001 receives a signal requesting an operation screen from the cellular phone 1004, the tablet computer 1005 and the personal computer 1003, etc., which are registered in the storage, the DTV 1001 is configured to transmit the current operation screen (operation screen data for questionnaire response) to the cellular phone 1004, the tablet computer 1005 and the personal computer 1003 via a short-range wireless system.

In this manner, a user (viewer) can respond to the questionnaire by operating the operation buttons on the screen of the cellular phone 1004, the tablet computer 1005 or the personal computer 1003, etc. The response data at this time is sent back to the service server via a network from the cellular phone 1004, the tablet computer 1005 or the personal computer 1003, etc.

In the above explanation, inquiry data is specifically described as multiplexed in the broadcast program. However, in other embodiments, only notification for informing that inquiry data such as a questionnaire has been distributed via a browser or an e-mail may be viewed. For example, the address of a server which a viewer should access, an email address and comments may be displayed as scrolling subtitles. The comments may be simple as follows: “We are now conducting a survey on . . . . Contact us on the following e-mail address.”

The above-described transmission of inquiry data (which may be also referred to as activation data) in connection with the broadcast signals of a poplar program can be the starting point for collecting many items of questionnaire data.

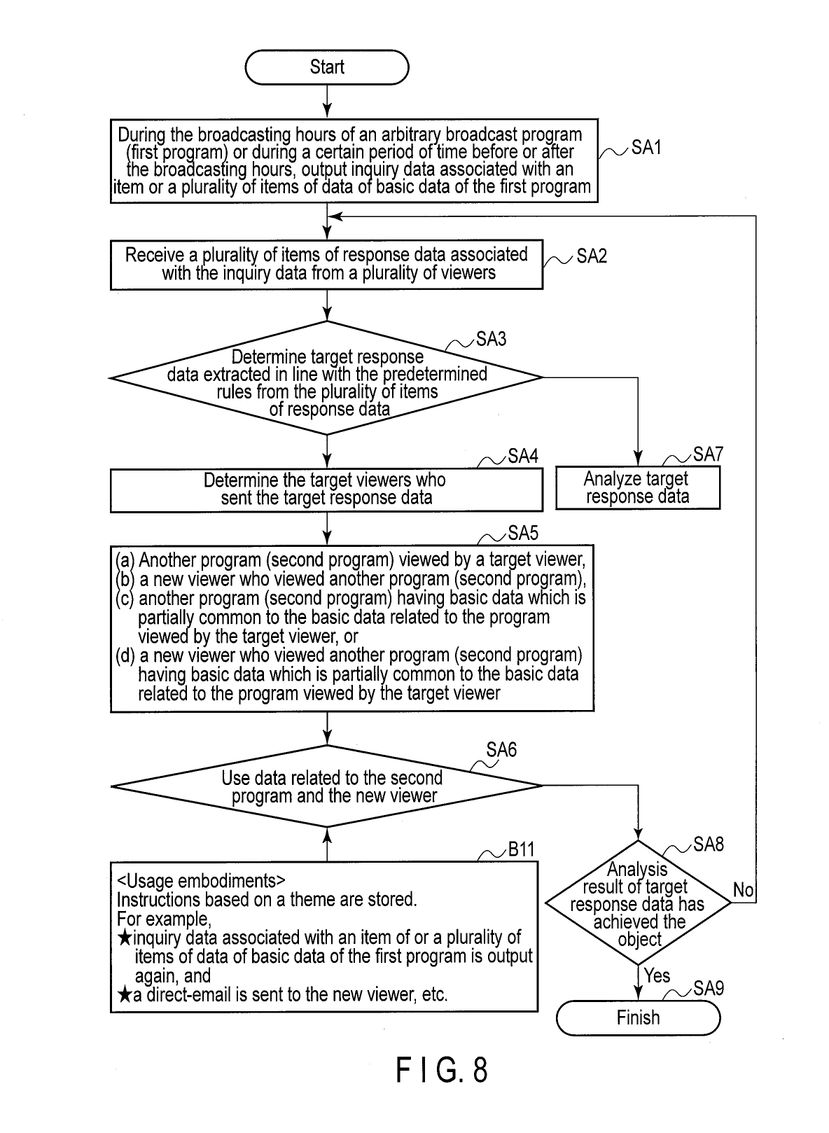

FIG. 8 illustrates a flowchart showing an example of behaviors of the above system. The theme execution engine 4014 within the service server 4001 reads a program (or software) stored in the theme storage 4015, and initiates a process related to a theme based on the program.

Firstly, during the broadcasting hours of an arbitrary broadcast program (first program) or during a certain time slot before or after the broadcasting hours, inquiry data associated with an item or a plurality of items of basic data of the first program is output based on the request from a requester (step SA1). Inquiry data is output via the transmitter controlling logic 4035.

Response data from viewers is loaded from the receiver via the receiver controlling logic 4011. From a plurality of viewers, a plurality of items of response data associated with the inquiry data are received (step SA2).

The response data analysis engine 4013 determines target response data among a plurality of items of response data in line with the predetermined rules (step SA3).

The predetermined rules are set by the requestor depending on the theme. For example, questionnaire is described as follows:

Give us your opinion about the car in the commercial.

| | | |
|---|---|---|
| *Want to buy | Yes | No |
| *Want to test-drive | Yes | No |
| *Good design | Yes | No |
| *Good color | Yes | No |
| *. . . | | |

In reply to this questionnaire, the response data of “*Want to buy—Yes” is extracted as target response data at the first priority level. The response data of “*Want to test-drive—Yes” is extracted as target response data at the second priority level (step SA3).

In step SA7, target response data is further analyzed. For example, if “No” is included in target response data, the target response data is analyzed regarding in which item “No” is included. The target response data is also analyzed regarding whether or not the number of items of target response data has reached the target number. The method, contents and procedures of this analysis are also set depending on the theme.

In the next step SA4, the target viewer who sent the target response data is determined.

In the next step SA5,

(a) identification data of another program (second program) viewed by the target viewer,

(b) identification data of a new viewer who viewed the above program (second program),

(c) identification data of another program (second program) having basic data which is partially common to the basic data related to the program viewed by the target viewer,

(d) identification data of a new viewer who viewed another program (second program) having basic data which is partially common to the basic data related to the program viewed by the target viewer, or

(e) the combination of the identification data is extracted.

In the next step SA6, the use of the identification data of the program described as “another program” above and the identification data of a new viewer is executed. The use means that, for example, inquiry data is broadcast again together with the program, and inquiry data is transmitted to a new viewer. When inquiry data is transmitted to a new viewer, the data may be transmitted to a mobile device or a personal computer by e-mail via a network, or the mail box of a DTV, etc., is used.

The number of second programs described above may be more than one. The number of new viewers may be also more than one.

The specific method for using the identification data of a new viewer and the identification data of a program is set, for example, by the instruction stored in block B11. The instruction relies on the theme. For example, the following procedures (a1) to (e1) may be executed for the above use.

(a1) For example, when another program (second program) is broadcast, inquiry data requesting the following questionnaire may be output similarly to the previous step SA1:

Give us your opinion about the car in the commercial.

| | | |
|---|---|---|
| *Want to buy | Yes | No |
| *Want to test-drive | Yes | No |
| *Good design | Yes | No |
| *Good color | Yes | No |
| *. . . | | |

Thus, when inquiry data was output together with a different program more than once, more items of response data can be obtained. In this case, it is possible to expect that response data can be obtained from a viewer different from the viewer of the first program.

(b1) For example, the transmission of an advertising e-mail based on the theme to a new viewer who viewed another program (second program) or the target viewer who sent the response data may be arranged.

(c1) For example, when another program (second program) having basic data which is partially common to the basic data related to the program viewed by the target viewer is broadcast, inquiry data related to the questionnaire similar to the previous step SA1 may be output.

(d1) For example, the transmission of an advertising e-mail based on the theme to a new viewer who viewed another program (second program) having basic data which is partially common to the basic data related to the program viewed by the target viewer may be arranged.

(e1) For example, the above procedures (a1) to (d1) may be arbitrarily combined with each other for execution.

In step SA8, whether or not the analysis result of target response data has accomplished the purpose is determined. For example, whether or not the number of collected items of target response data exceeds the predetermined value, or whether or not the number of transmitted direct e-mails goes beyond the predetermined value is determined. If the analysis result has achieved the object, the data process ends.

As described above, in this system, the target viewer who sent back target response data is specified. By using a data file, the next new program and the next new viewer can be extracted based on the target viewer. Therefore, the target of transmission of inquiry data expands (or extends). In the case where target response data exists although inquiry data is transmitted to a small point, the transmission destination of “inquiry data” and “inquiry data in the next stage” can be expanded depending on the need as if a wave pattern spreads. Of course, in this case, the number of transmission destinations of “inquiry data” and “inquiry data in the next stage” can be limited. The level of this limitation can be changed or decreased depending on the degree of accomplishment of the purpose of the theme (investigation purpose, response contents, etc.).

When target response data is selected, positive response data is not necessarily selected in reply to a question and a questionnaire. Negative response data may be selected as target response data depending on the theme.

For example, when response data indicating that the viewer does not want to buy or test a drive exists in reply to the questionnaire of an automobile, this response data can be used as information for investigating reasons for unpopularity.

The examples of behaviors of the file controlling logic portion can be summarized as follows.

The file controlling logic portion 4003 comprises the transmitter controlling logic 4035 configured to output inquiry data associated with an item or a plurality of items of basic data of an arbitrary first program during the broadcasting hours of the first program or during a certain period before or after the broadcasting hours. The file controlling logic portion 4003 also comprises the reception controlling logic 4011 configured to receive a plurality of items of response data associated with the inquiry data from a plurality of viewers. The file controlling logic portion 4003 further comprises logic configured to extract target response data in accordance with the predetermined rules from the plurality of items of response data, and logic configured to extract the target viewer who transmitted the target response data.

Moreover, the file controlling logic portion 4003 comprises logic configured to extract:

identification data of a second program which is another program viewed by the target viewer;

identification data of a new viewer who viewed the second program;

identification data of the second program having basic data which is partially common to basic data related the first program viewed by the target viewer;

identification data of a new viewer who viewed the second program having basic data which is partially common to the basic data related to the first program viewed by the target viewer; or

combination of the above identification data.

The program which is firstly specified in order to firstly transmit inquiry data may be specified as follows. In the case where a DTV is configured to accept a login operation, login data is transmitted to the service server 4001. The service server 4001 constructs a data file, associating a program viewed by a viewer with the viewer based on the login data. When inquiry data related to the program is next transmitted, the inquiry data is transmitted to the viewer who viewed the program by reference to the data file. Since there are various methods for displaying a login screen, various methods for inputting login data, various methods for login for each group and various methods for login for each person as conventional art, this specification does not especially explain these methods.

In the data file 4002, basic data indicating a plurality of attributes related to a program is defined. The data file 4002 can be described as a file including a first data file in which basic data of a plurality of programs are stored, a second data file which associates viewers with a plurality of programs, and a third data file which associates programs with a plurality of viewers. However, the definition of the data file 4002 is not limited to the above descriptions.

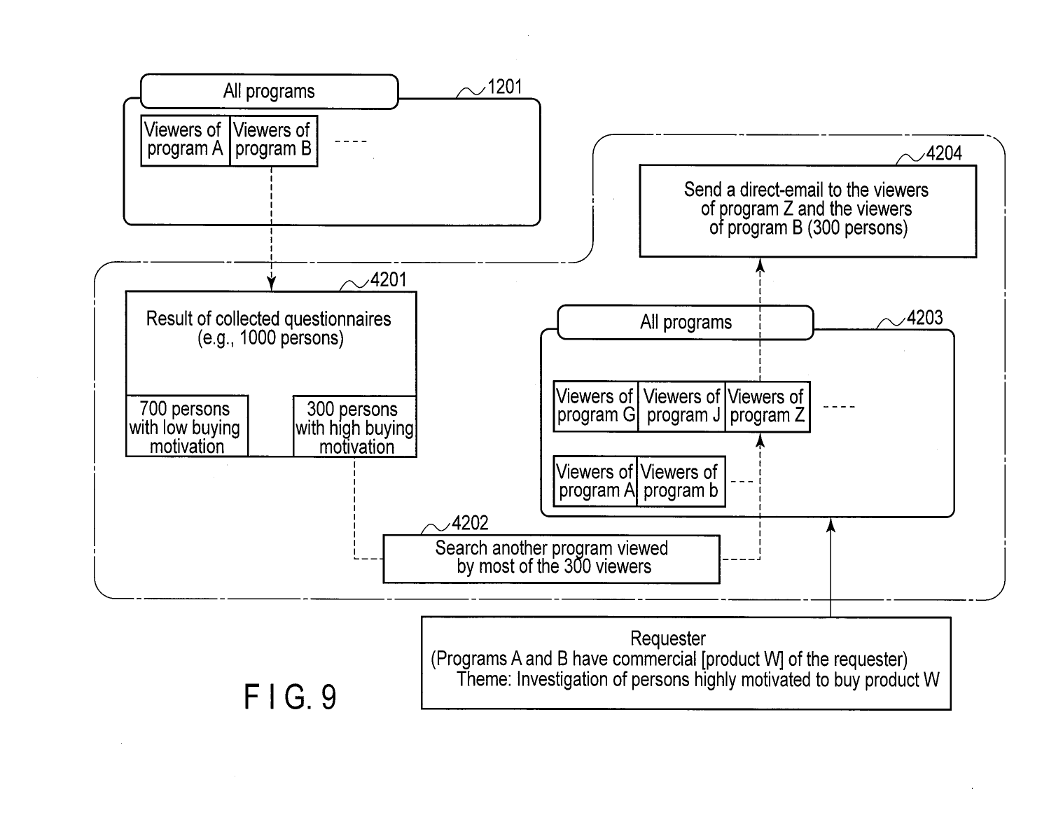

FIG. 9 shows an example of use of the above-described system. For example, a requester who is a sponsor of programs A and B may want to know the market trend of commercial (CM) product W. In this case, inquiry data is broadcast during the hours of programs A and B or during a certain period after the end of programs A and B. For example, inquiry data is a questionnaire for investigating the consumer appetite of product W.

Response data is sent back to the service server side from a viewer space (1201). In the example of FIG. 9, a questionnaire collection result portion in which the analysis result of response data is stored is illustrated. The example shows that, among 1000 respondents, 700 persons have low motivation for purchasing product W, and 300 persons have high motivation (4201).

For example, a different program viewed by most of the 300 viewers who have high buying motivation is searched in line with procedure rules (4202). If the program is program Z, a viewer corresponding to program Z is detected from the data file in which the data of a plurality of programs each associated with viewers is stored (4203) because the viewer of program A is presumed as having the similar preference to the viewer of program Z.

After that, the requester or the service server transmits a direct e-mail to the viewer of program Z (4202).

As described above, the behaviors of this system have a feature of extending the distribution destination of a questionnaire and the next notification (report, inquiry, guide, etc.) destination based on the questionnaire result.

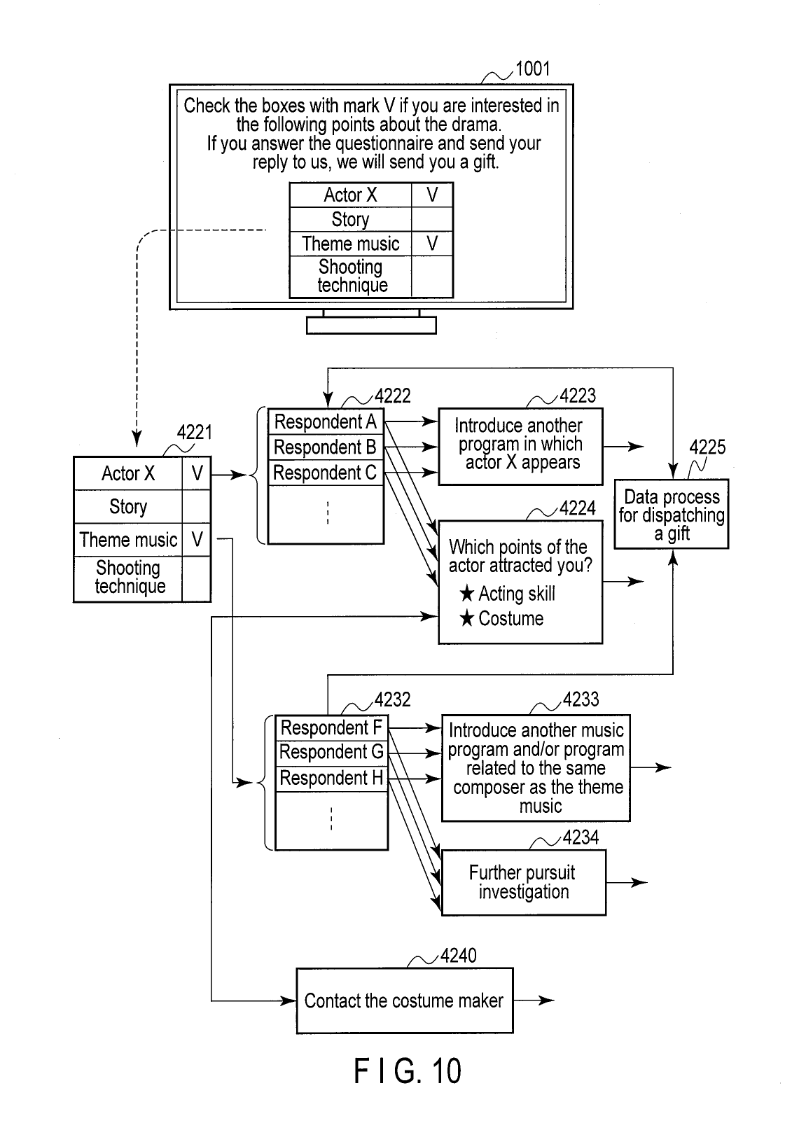

FIG. 10 shows another example of behaviors of this system. For example, after the end of drama program Y, the following inquiry data is displayed: “Check the boxes with mark V if you are interested in the following points about the drama. We will send you a gift if you answer the questionnaire.”

The items of inquiry data are, for example, “actor”, “story”, “theme music” and “shooting technique” (4221).

For example, if viewers A, B and C respond to the service server 4001, checking “actor X” and “theme music” with the mark (4222), the theme requested by the requester is executed in the service server 4001. For example, the theme is configured to introduce the different program Z in which actor X plays into viewers A, B and C (4223). As a further pursuit survey, the following question items can be also sent to viewers A, B and C: “Which points of actor Y attracted you?—Acting skill? Costume?” (4224). Moreover, regarding the drama, a question of “Do you want to watch next episode 2 as well?”, etc., can be transmitted.

For the respondents (viewers A, B and C), a data process for dispatching a gift is executed in order to send a present (4225). This data process lets a delivery company of the present know about the addresses of the respondents, etc.

If there is a response showing interest in the costume of actor Y, it is possible to contact a costume maker as an expanded behavior (4240).

If there are viewers F, G and H who are interested in theme music (4232), other music programs and/or other programs related to the composer of the theme music can be introduced into viewers F, G and H (4233). A further pursuit investigation into viewers F, G and H can be conducted (4234).

For the respondents (viewers F, G and H), a data process for dispatching a gift is executed in order to send a present.

As described in the above examples, a theme is configured to have a plurality of purposes such as the investigation of popularity of actor X and the investigation of costume by a costume maker.

The DTV 1001 used in this system is not limited to the specific television receiver. However, if the DTV 1001 explained hereinafter is used, various types of data files can be automatically constructed in the service server 4001.

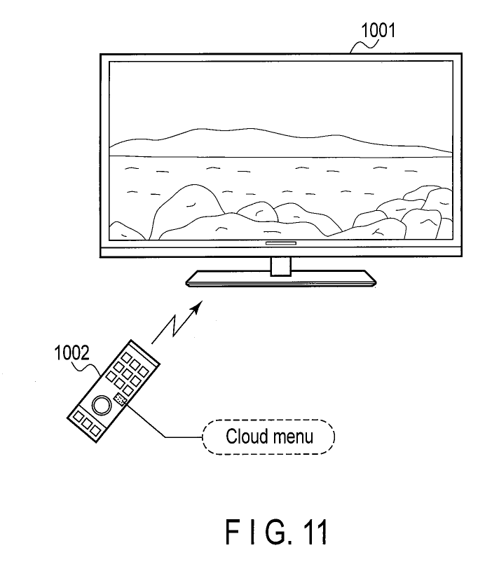

In the DTV 1001 shown in FIG. 11, similarly to the common TV, a program image of a reception channel is displayed on a screen in the normal state of use. For example, if the predetermined cloud menu button is operated by a remote controller operation, the connection to the service server 4001 becomes possible. This connection state could form the state explained in FIG. 1. This type of DTV 1001 is sometimes referred to as an Internet connection TV.

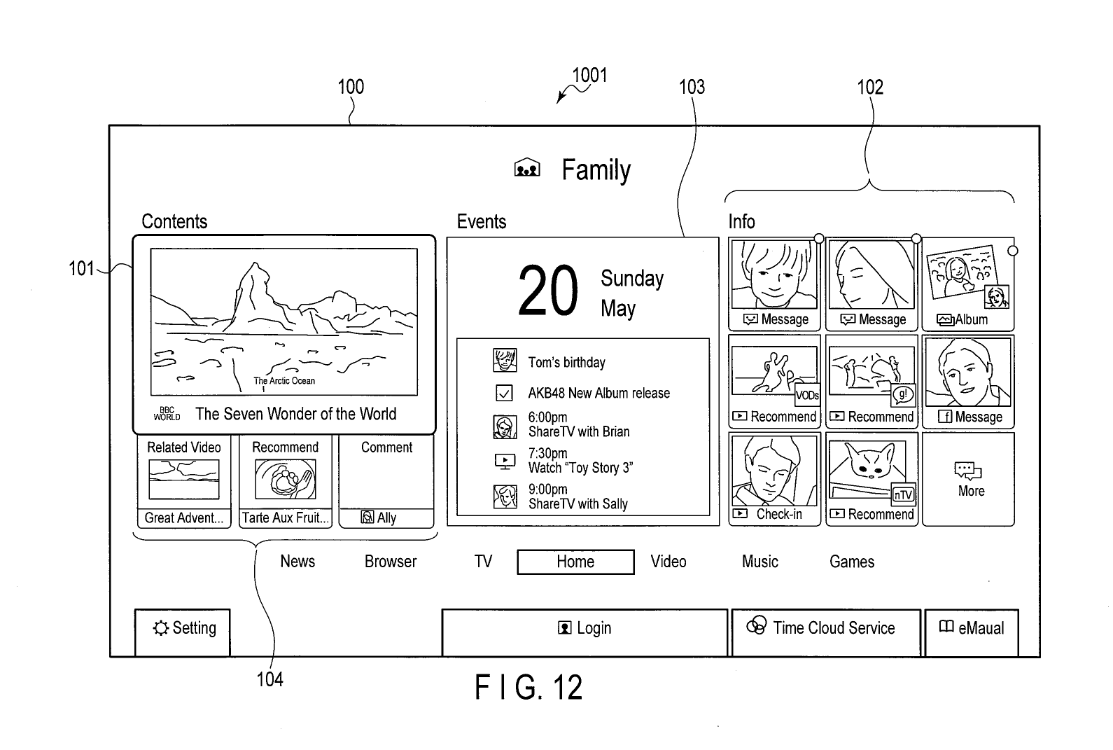

FIG. 12 shows a state at which the DTV 1001 is connected to the cloud service server 4001 and an initial menu screen 100 is displayed.

In a display area 102, guide images for various types of sending-and-receiving boxes to receive notifications from family and friends and recommendation data are displayed. There are sending-and-receiving boxes for outlook, e-mail, message and recommendation data, etc. A unique name can be added to the screen frame showing each sending-and-receiving box. It is also possible to select a favorite image from an image file and add the selected image as a guide image.

If a message or recommendation data has been received in a sending-and-receiving box, for example, a corresponding guide image is displayed with a circular mark, with a changed frame color, or with the brightness of the frame repeatedly changed. If a plurality of items of recommendation data have been received in a sending-and-receiving box, a corresponding guide image may be displayed with a plurality of circular marks, or the number of received items of recommendation data may be described on the frame.

For example, the above sending-and-receiving box (at the state of the display area 102) can be used for communication between family members and communication between a family member and a friend. An album may be transmitted from a fried or a brother who lives away from home. Recommendation data may be transmitted from a friend. Recommendation data is, for example, recommended program information, recommended shopping information, recommended scene information or recommended performer information.

Moreover, a plurality of functional guide images are displayed in an area 104 under an area 101. The functional guide images are used when a user operates the DTV 1001 in connection with the replay picture displayed in the area 101. The guide images can be used when, for example, a viewer (user) communicates with an external server (another user) in connection with the replay image displayed in the area 101.

<Usage Examples of Guide Images in Display Area 102>

For example, a user can operate a remote controller (a mobile device may serve as a remote controller), and set the cursor on the desired guide image (for example, the guide image for a message from a mother to a child). The guide images may be referred to as operation buttons. For example, a cursor is displayed as a frame surrounding a guide image. When a cursor is positioned on the desired guide image and the confirm button of the remote controller is pressed (clicked), the sending-and-receiving box corresponding to the guide image is opened, and for example, a message is displayed. For the message, for example, all of or a half of the area 102 can be used.

A user can also operate a remote controller and open the sending-and-receiving box for recommendation data. Recommendation data may be, for example, recommended program information showing a recommended program sent from a friend, or recommended shopping information. A user may be interested in the recommended program and want to watch the program. If the user sets the cursor on the selection button of the recommended program information which is displayed and presses the confirm button, the DTV 1001 is configured to automatically begin the reproduction of the program. In this case, the replay image of the program may be displayed in the small screen, and the image may be displayed in the large screen when the user presses the confirm button next time.

The sending-and-receiving boxes can be also used when a message is transmitted to the sending-and-receiving box of the communication partner or a mobile device. Recommended program information is displayed as, for example, a title name, some scenes within a program, a performer name or the image of a performer. Recommended program information also includes a broadcasting channel number, a broadcasting date and time, the information of cast prologue and a contents server address, etc.

The DTV 1001 obtains program contents by means of the first method and the second method. In the first method, a recording device connected to the DTV 1001 is driven to obtain program contents. In the second method, program contents are downloaded from the contents server via the Internet. In the first method, a program list search function of a program recorded in the recording device is operated. In the second method, the address of the contents server included in the previous recommended program information is used.

By using the guide images of the display area 102, e-mails and short messages, etc., can be transmitted to a family member or a friend registered in an administration device which controls the guide images. In this case, a friend is a friend common to the members of the family. Information of other families and friends common to the members of the family is recognized and registered in an administration device for a family. In the administration device, the guide images for a family are stored and controlled.

<Usage Examples of Guide Images in Display Area 104>

For example, in the drama program which is currently viewed and displayed in the area 101, a user may have a favorite scene or a scene in which a favorite star appears. If a user operates a remote controller, selects the guide image for the recommend and presses the confirm button, the program information of the program viewed by the user is uploaded to the server as attention (or notice) program information. The server can use the attention program information as material for generating recommended program information and/or information for generating a tag list of the program. Since attention program information related to various programs is sent from many viewers to the server, the server is configured to conduct a statistical process, using the attention program information. By conducting the statistical process, a program information list in which programs are arranged in descending order of popularity can be prepared.

Moreover, a user can operate a remote controller, select the guide image for the comment and press the confirm button. At this time, a screen for inputting a short message regarding the program which is viewed by the user and displayed in the area 101 appears, and the user can input a message. A message can be input from, for example, a remote controller or the keyboard display of a mobile device.

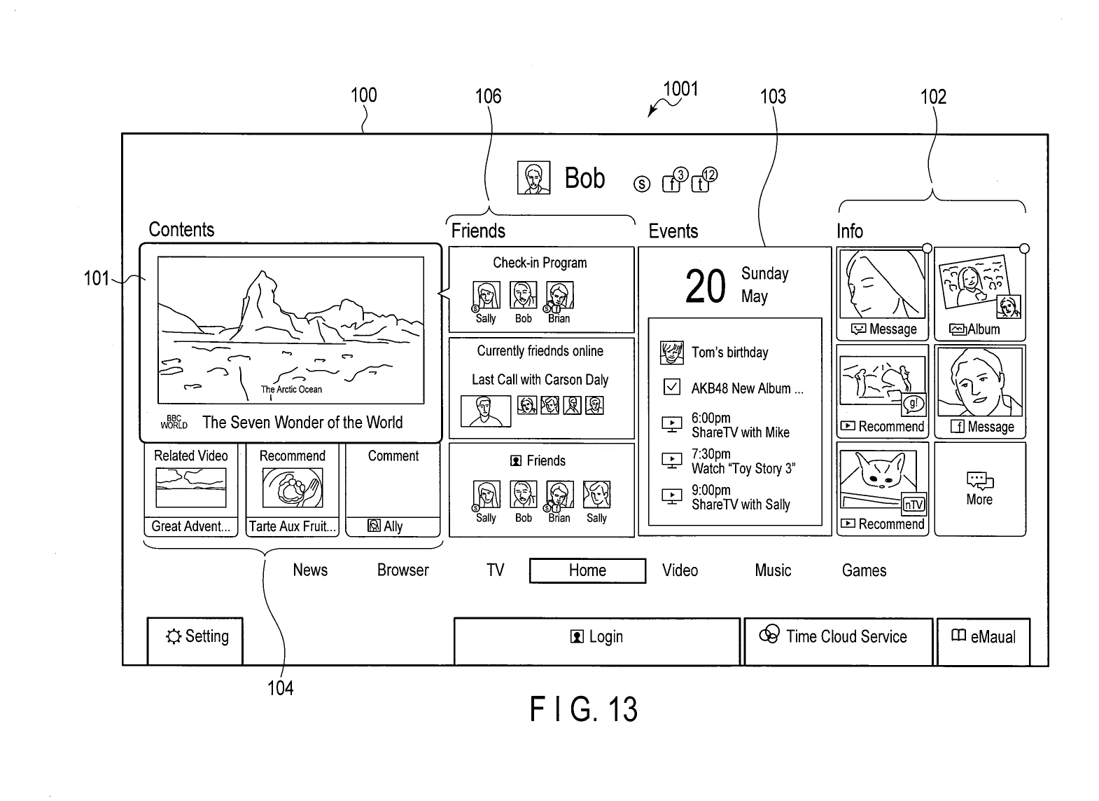

FIG. 13 shows the display state of the screen 100 when the DTV 1001 is connected to the cloud service server via the network and logins the server with a personal ID. In the screen 100, a display area 106 for guide images for communicating with friends can be obtained between the area 101 and an area 103. In the display area 106, for example, three types of guide images exist. As the top guide image (Check-in Program), a list of others (friends) who are concurrently viewing the program currently viewed by the user is displayed. As the middle guide image (Currently friends online), a list of others (friends) who are viewing a program different from the program currently viewed by the user is displayed. However, the DTVs 1001 of these friends are connected to the network. As the lower guide image (Friends), a list of others (friends) whose DTVs 1001 are not connected is displayed. The state at which the DTV 1001 logins is regularly sent to the server. Therefore, the server is configured to identify a user (DTV) who is not connected to the network, a user (DTV) who is connected to the network and a user (DTV) who is connected to the network and is viewing the same program. Thus, the server monitors the status of a plurality of users, and reports the status to each user. Therefore, the DTV 1001 is configured to present three types of guide images shown in the display area 106. Each user registers friends in the friend register of the server in order to associate friends with each other.

<Usage Examples of Guide Images in Display Area 106>

For example, if son B of friend A appears in the currently-viewed drama program, the user may want to notify friend A or the family of friend A of the fact. If friend A searches a lost dog C and the user views news of dog C, the user may want to inform friend A or the family of friend A as to the news. In these cases, the user can use the guide images displayed in the area 106.

A user can operate a remote controller, select the guide image displaying the desired friend by a cursor, and press the confirm button. If the user presses the button, the screen can be transferred to the state at which a message can be sent to the selected friend.

For the above communication, the guide images which describe the recommend and message in the display area 102 can be also used. A user can operate a remote controller, select the guide image displaying the desired image by a cursor and press the confirm button. In this case, a message can be sent to the family or person registered in the sending-and-receiving box of the selected image. The guide images of the display area 106 can be used mainly for private communication.

<Usage Examples of Guide Images in Display Area 103>

In the guide images in the display area 103, a calendar is displayed. In addition, events and schedule titles on the day are simply displayed. When a user wants to know the detailed information of an event or a schedule, the detailed information is further displayed by selecting the event or the title of the schedule with a cursor and clicking the event or the title. For example, the detailed information can be browsed at a URL.

In the above calendar, the schedules of a user, etc., can be described. When the display area of the calendar is selected with a cursor, the items in use of the calendar are displayed. When the schedule writing item is selected, a schedule can be input from a remote controller or a mobile device.

<Move of Operation Screen>

Excluding the viewing image of the area 101, the above-described guide images can be also displayed in a mobile device comprising a displaying portion which is a touch type of input operating portion. The DTV 1001 is configured to transfer the above guide images and operation signals corresponding to the guide images to a mobile device through a communication function. Thus, the mobile device is configured to maintain the communication state with the DTV 1001 and operate the DTV 1001 by the use of the guide images as described above.

<Examples of Block Structure of DTV 1001>

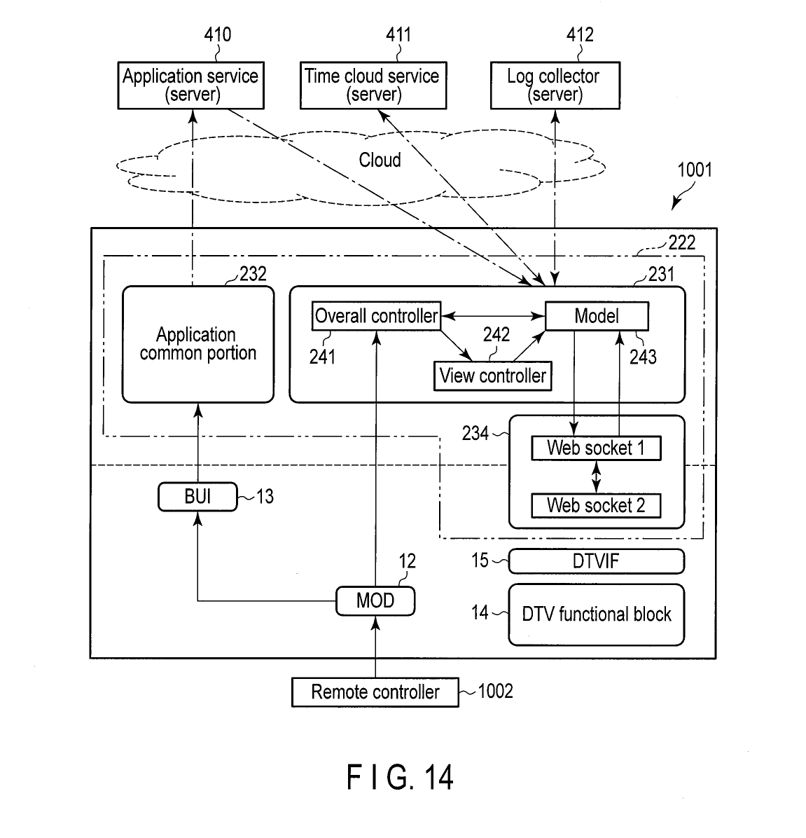

FIG. 14 shows the state of the case where a DTV according to one embodiment is used on a network. In the DTV 1001, basic functions as a television (television signal reception, demodulation, control signal processing, 3D associated signal processing, recording, audio processing, video processing and display function, etc.) are shown as a DTV functional block (or module) 14 as a whole. The DTV functional block 14 is connected to an information processor 222 through a DTV interface 15. The information processor 222 may be referred to as a browser section.

In this example, the information processor 222 comprises a cloud application portion 231, an application common portion 232 and a socket portion 234. Classification is not limited to this example, and the cloud application portion 231 may be defined as the information processor 222.

The socket portion 234 comprises a server Web socket from the perspective of the DTV interface 15 and a client Web server from the perspective of a browser.

The cloud application portion 231 comprises an overall controller 241, a view controller 242 and a model 243. The overall controller 241 conducts various event processes in reply to commands and instructions. The overall controller 241 realizes various drawing processes by controlling the view controller 242. The view controller 242 is configured to obtain various types of images and controlling signals within the screen 100 explained before. The images and controlling signals based on the operations of the view controller 242 are reflected as images and controlling buttons in the display portion of the TV apparatus via, for example, the model 243 and the socket 234.

The model 243 accesses a server, obtains information from a server, transmits information to a server, operates a DTV and receives data from a DTV, etc. Therefore, it is possible to receive a message from a DTV and transmit the message to a server. Moreover, the message received from a server can be displayed on the screen of the display portion of a DTV in cooperation with the view controller 242. The server may be an application service server 410, a time cloud service server 411, or a log collector server 412, etc. Further, there are other types of servers (not shown in the figure).

A user can operate a remote controller 11 to control a DTV and the information processor 222. The operation signals from the remote controller 11 are distributed in a moderator 12. The key event distributed for the cloud application portion 231 is input to the overall controller 241. The key event distributed for the application common portion 232 is input to the application common portion 232 through a browser user interface 13. The application common portion 232 is configured to request the application specified for the application server 410 in accordance with the application request command. The application sent from the application server 410 is loaded into the cloud application portion 231 through the model 243. The log collector server 412 is configured to collect a log used in the information processor 222 and other connection devices.

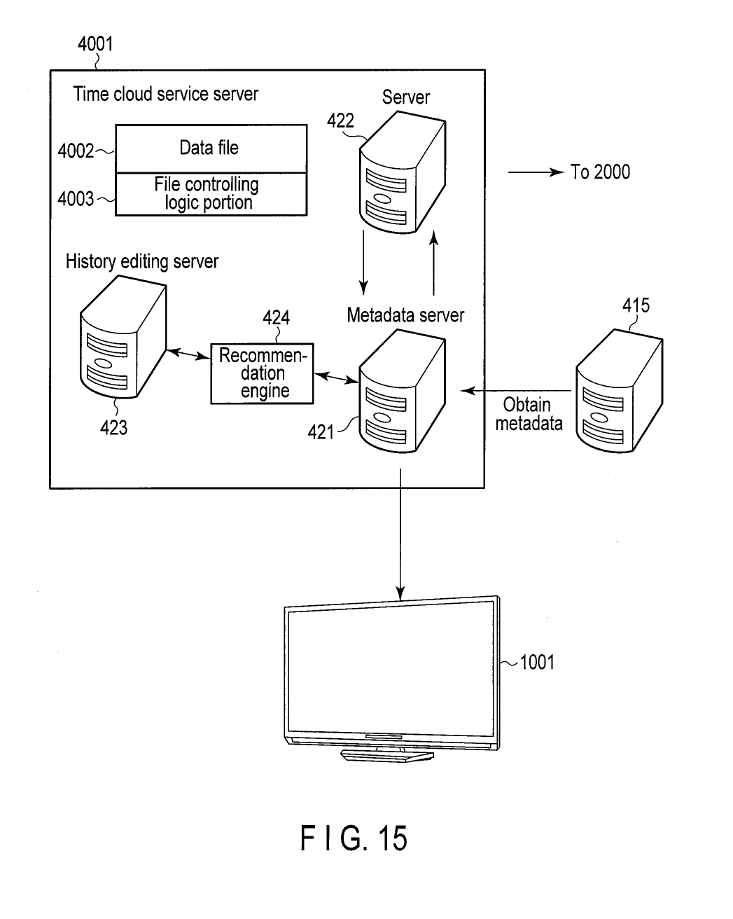

FIG. 15 shows a structure example of each server forming the time cloud service server 4001. In the time cloud service server 4001, the data file 4002 and the file controlling logic portion 4003 which are shown in FIG. 1 exist. The data file 4002 and the file controlling logic portion 4003 may be stored in any server explained below.

A metadata server 421 is configured to receive various types of items of metadata from a data generation server 415 of an external data generation company. Metadata is program information, and includes much information related to a program such as the broadcasting channel, broadcasting time and cast. Metadata is used for preparing scene information, a tag list and a scene list in the metadata server 421. Control information associated with a tag list, a scene list and scene information also exists.

The metadata server 421 is configured to register a tag list and/or a scene list in a tag list preparation server 422. The metadata server 421 is configured to obtain a tag list and/or a scene list from the tag list preparation server 422 in response to the request from a client (information processor), and provide the client (information processor) with the tag list and/or the scene list. The metadata server 421 is configured to generate scene information, using metadata, and transmit the information to the client (information processor).

From many clients (users), the metadata server 421 collects, for example, information of scenes in which clients are interested and recommendation data, and transmits the information to a history collection server 423. The history collection server 423 takes the statistics of program information of information of scenes in which users are interested and/or program information included in the recommendation data. Based on this statistics process, the rank order of a plurality of scenes which have been specified many times by program information is determined for each program. Within one program, a plurality of scenes at high rank are determined as representative scenes, and representative information corresponding to the representative scenes is prepared. Thus, in each program, a plurality of representative scenes are determined. Representative scene information includes the program title, the broadcasting date and time of the program and the relative time until the transition to the reproduction of the representative scenes in the case where the program is replayed from the beginning, etc.

If a client requests scene play, the metadata server 421 is configured to cause the server 423 to send representative scene information related to the requested program to the client.

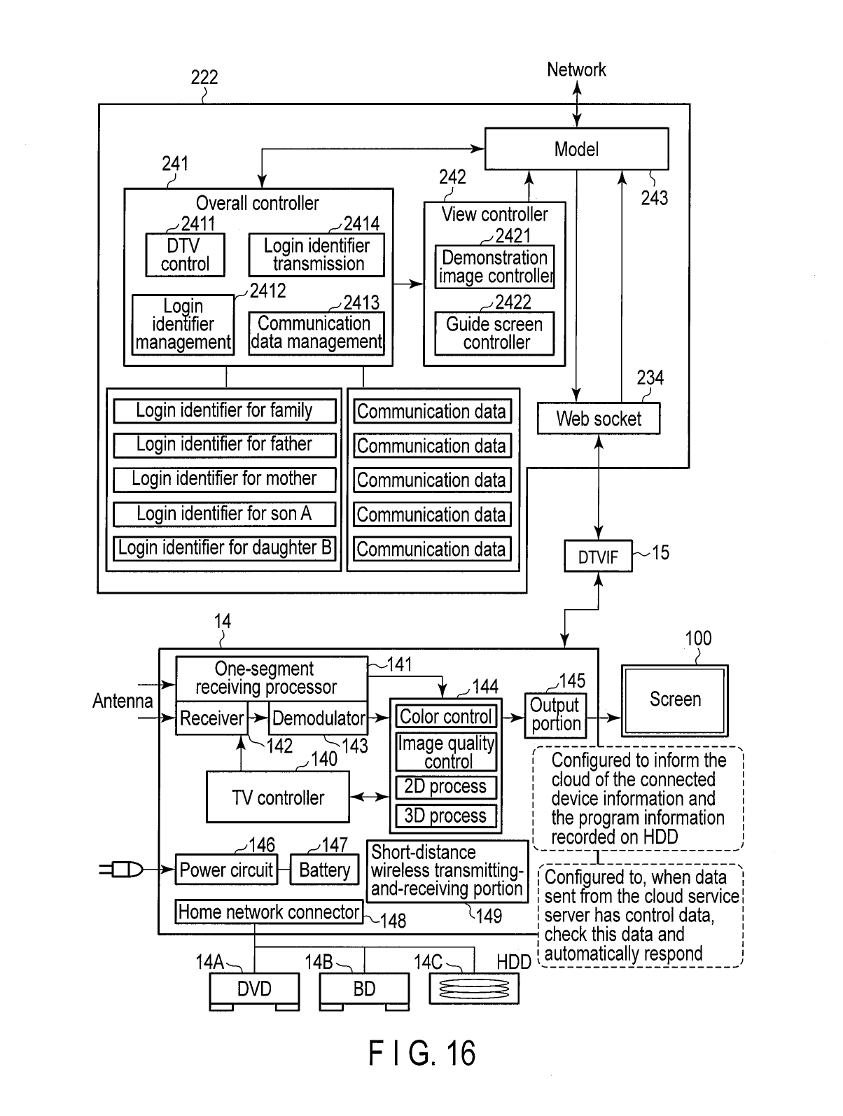

FIG. 16 shows the structure examples of the information processor 222 and the DTV functional block 14, associating them with each other. The overall controller 241 comprises a DTV controller 2411, a login identifier managing module 2412, a communication data managing module 2413 and a login identifier transmitter 2414.

The DTV controller 2411 may control the DTV functional block 14 based on a user operation, and may control the DTV functional block 14 based on the control data from the cloud service server 411. When a login operation is conducted and a login identifier is input, the login identifier managing module 2412 controls the save of the login identifier, and manages login identifiers for a family and an individual as table data.

The communication data managing module 2413 manages communication data, dealing with each login identifier. For example, when the login user accesses an external server, this history data is managed. The history data includes the accessed address and transaction data. The communication data managing module 2413 is configured to classify and save data sent from the cloud service server 411, and is also configured to use the data as data for display.

The login identifier transmitter 2414 transmits the login identifier used for login to the cloud service server 411. The cloud service server 411 manages login identifiers from many users and uses them when offering the guide images previously explained in the menu screen.

The view controller 242 comprises a demonstration image controller 2421 and a guide screen controller 2422. By this structure, demonstration images and guide images can be offered to the DTV side.

The DTV functional block 14 comprises a one-segment receiving processor 141 configured to receive signals from an antenna, a receiver 142 configured to receive satellite broadcasting and terrestrial digital broadcasting, and a demodulator 143. The receiver 142 and the demodulator 143 comprise a plurality of tuners and are configured to simultaneously receive and demodulate broadcasting programs of a plurality of channels.

A plurality of demodulated program signals can be converted into a DVD (registered trademark) format in a DVD (registered trademark) device 14A and recorded in a digital versatile disk. Alternatively, the demodulated program signals can be converted into a BD (registered trademark) format in a BD (registered trademark) device 14B and recorded in a Blu-ray (registered trademark) disk. An arbitrary stream can be recorded in a hard disk in a hard disk drive 14C.

The DVD device 14A, the BD device 14B and the hard disk drive 14C are connected to the DTV functional block 14 via a home network connector 148. The hard disk drive 14C may be connected via a USB cable. The hard disk drive 14C may, for example, simultaneously record all programs of a plurality of channels (for example, six channels which were set) for approximately, for example, one to three weeks. This type of function is sometimes referred to as a time-shift function. Moreover, a hard disk drive may be additionally provided.

The network connection device and the recorded program information are controlled in a TV controller 140 and may be transmitted to the cloud service server 411 via an information processor. In this case, the cloud service server 411 is configured to ascertain the network connection device and recorded program information at the user's home. Therefore, when various types of scenes are reproduced based on scene list information, the cloud service server 411 is configured to specify even the connection device in which the scenes have been recorded at home.

Within the DTV functional block 14, the demodulated program signals or the program signals reproduced from a recording medium such as a DVD, a BD or a hard disk (HD) are adjusted in various ways (brightness adjustment and color adjustment, etc.) and displayed on the screen 100 which is a display portion via an output portion 145.

The DTV functional block 14 comprises a power circuit 146 configured to arbitrarily switch its state of use to an AC power use state or a battery use state 147. This switching of the power use state may be forcibly conducted by a user with a remote controller operation, or may be automatically implemented based on external information.

The cloud service server 411 is configured to transmit a control signal which automatically switches a TV device to a 3D processing state. Furthermore, the cloud service server 411 is configured to transmit an audio controlling signal and/or an audio signal based on each scene to a TV device. Moreover, the cloud service server 411 is configured to transmit extended chain data including adjustment data of an image depending on the scene.

The DTV functional block 14 comprises a short-distance wireless transmitting-and-receiving portion 149. It is possible to transmit data to a mobile device or receive data from a mobile device via the short-distance wireless transmitting-and-receiving portion 149. A mobile device is configured to require an operation image from the DTV functional block 14. When an operation image is required, the DTV functional block 14 is configured to transmit a guide image to the mobile device. A user can control the above information processor, using the guide image of the mobile device.

A user can connect a mobile device to a network, using a guide image. Thus, it is possible to obtain a communication state between a mobile device and the cloud service server.

The DTV functional block 14 is configured to check the control data sent from the cloud service server 411, and automatically reflect the data as an operation state.

According to the above-explained system, basically, the information processor transmits data (control signals corresponding to a scene information key, a scene list key and a scene play key) which is a trigger to the server via the network connector in response to the first operational signal of a user. Next, the information processor obtains extended chain data which is sent back based on the trigger data, and classifies and saves the first control signal (instruction) which is included in the extended chain data and is used for automatic control, and the second control signal (instruction) which responds to the second operational signal of the user. The signals are saved in the overall controller or the model. An autonomous operation can be conducted based on the first control signal (instruction), and/or a heteronomous operation can be conducted based on the second control signal (instruction).

An autonomous operation means that the operation is automatically performed. For example, the operation is the acquisition of the display image of the area 106 and the control of the DTV functional block 14. A heteronomous operation means the wait for a user operation. This operation means the response to the second operational signal when the second operational signal is input from the user.

This operation is an operation to respond to inquiry data, an operation to respond to tag list selection and an operation to respond to scene list selection, etc. Further, extended chain data includes data for display. This data for display includes various types of messages and albums. When an instruction to save electricity is sent from the time cloud service server 411, the DTV functional block 14 is configured to implement an operation for saving electricity. For example, in order to save electricity, the DTV functional block 14 switches a full-segment reception state to a one-segment reception state, contracts the display area of the display portion, or changes AC power use to battery use.

The DTV functional block 14 is configured to control the brightness of the area of a dynamic picture image of the area 101 so as to be higher than the brightness of the other areas. It is possible to lower the brightness of the guide images of the areas 102 to 104 than the dynamic picture image of the area 101. Thus, the visualization of dynamic picture images can be improved. However, for an operation, the brightness of the guide image pointed with a cursor can be controlled so as to be light.

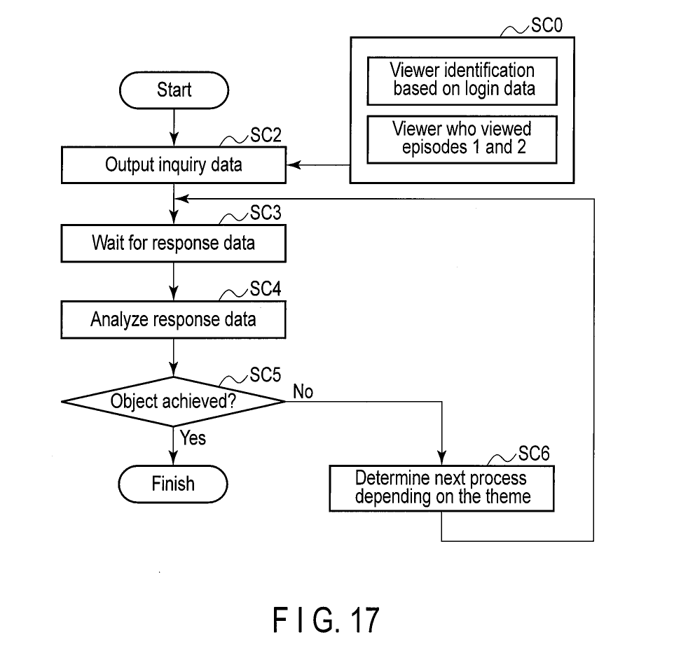

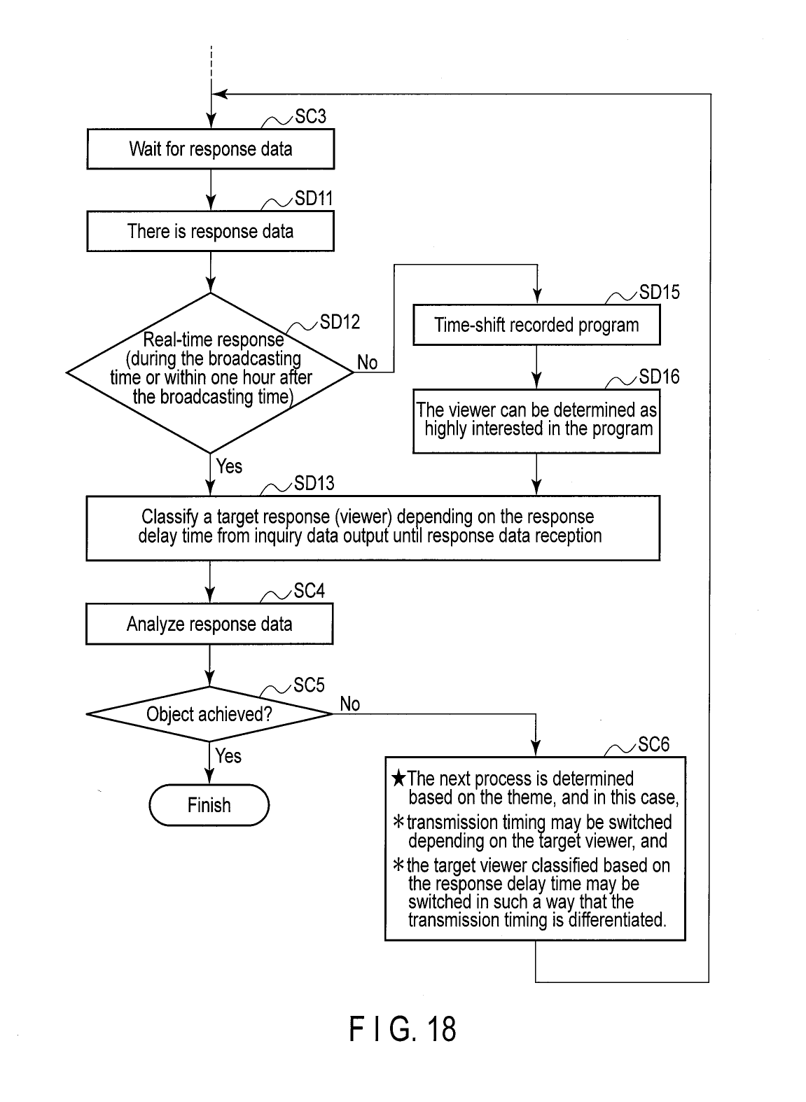

FIG. 17 and FIG. 18 are flowcharts shown for explaining other behavior examples in the file controlling logic portion 4003. These flowcharts may be also implemented in combination with the previously-explained embodiments.

FIG. 17 indicates another example for specifying a viewer when transmitting inquiry data to the viewer. As described above, if the DTV 1001 logins the cloud server 4001, the DTV 1001 is configured to notify the cloud server 4001 which program is viewed by the viewer and in which channel the program is broadcast.

The cloud server 4001 is configured to construct a data file including the information of which viewer viewed which program, and the information of whether or not episode 1 and episode 2 of the program were viewed. The cloud server 4001 is configured to know which viewer views which program.

In database SC0, identification data of a viewer specified based on the login data generated in a login operation, and identification data of a program viewed by the viewer are stored. Further, if the program is a soap opera, database SC0 includes data indicating whether or not the viewer viewed episode 1, episode 2, . . . .

The service server 4001 outputs inquiry data of the program and waits for response data (steps SC2 and SC3). After response data is received, the response data is analyzed, and whether or not the object of a theme (for example, questionnaire investigation) has been achieved is determined (steps SC4 and SC5).

If the object achievement is insufficient, the next process is determined in accordance with the theme, and the state becomes a waiting state for response data (step SC6). As the next process based on the theme, the next question is asked to the same viewer, and/or the first inquiry data is transmitted to a new viewer, etc.

The DTV 1001 has a time-shift recording function. As the time-shift recording function, for example, all of the programs of the set six channels can be simultaneously recorded in a hard disk for, for example, one to three weeks.

Therefore, when a user reproduces a past program from a hard disk, the previous inquiry data might be displayed as, for example, subtitle data.

A user might respond to the inquiry data in the past program. In response to this kind of case, the cloud service server 4001 may operate as shown in FIG. 18.

The steps until the wait for response data are the same as the case in FIG. 17. When response data is received (step SD11), whether or not this response data is a real-time response is determined (step SD12). A real-time response is, for example, a response during the broadcasting time of the program, or a response within, for example, an hour from the broadcasting time (the amount of time is not limited).

If response data is not a real-time response, it is possible to determine that the viewer viewed a program of time-shift recording (step SD15). In this case, it is possible to determine that the viewer is highly interested in the program (step SD16).

In step SD13, in accordance with the response delay time from the transmission of inquiry data until the reply and reception of response data, target responses (viewers) are classified. In sum, the viewers who responded in real time are separated from the viewers who responded after they viewed a time-shift recorded program.

Response data is analyzed (step SC4). Whether or not the analysis result has achieved the object is determined (step SC5).

When the object has not been achieved, the next process is determined in accordance with the theme (step SC6). In this case, the transmission timing and contents of the next inquiry data, and the program multiplexed with inquiry data may be changed or switched in accordance with the target viewer classified in step SD13.

A reason for the above is as follows. For example, there is a possibility that the program viewing time slot of the viewers who responded in real time (real-time responders) is different from the program viewing time slot of the viewers who responded based on a time-shift recorded program (late responders).

The above classification of response delay time or target responses (viewers) may be based on smaller categories. If response data is replied within ten minutes from the real-time broadcasting, the viewer who responded is probably highly interested in the program.

The above-explained file controlling logic may be summarized as follows.

For example, file controlling logic is provided in a service server which is connected to a television receiver through a login operation. The file controlling logic portion comprises logic configured to access a data file which is constructed in such a way that a program viewed by a viewer is associated with the viewer based on login data. The file controlling logic portion further comprises, when inquiry data regarding the program is transmitted, logic for transmitting the inquiry data to the viewer who viewed the program with reference to the data file.

The above behavior procedure of the file controlling logic portion 4003 may be executed by a program by software, or may be constructed by hardware. In addition, for example, a program is stored in the memory of the theme storage. A requester can easily collect information of various themes such as opinions from viewers regarding a program and opinions from viewers regarding the cast, announcer and presenter. In the middle of the step for collecting information, the theme (or object) of information collection can be divaricated by a program.

The above file controlling logic portion 4003 is not limited to this name, and may be referred to as, for example, a controlling portion, a controlling means, a controlling module, a controlling chip and a controlling program portion. Each block within the file controlling logic portion 4003 may be also referred to as logic, a module, a means, a portion and a device, etc. Even if these blocks are shown with division or combination, they are within the technical scope explained in the embodiments.

Moreover, even if each structural element in claims is expressed with division of a component, combination of a plurality of components, or combination of the divided and combined components, the element falls within the scope of the embodiments of the present invention. Even if a claim is directed to a method, the apparatus of the embodiments is applied to the claim. The above-described embodiments may be constructed on a regional network, a home network, a network in a building and a network in a company, etc. The broadcast facilities may be broadcast facilities in a cable television (CATV) system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. An associated-data processor comprising:
a data file comprising
basic data indicating attributes related to each program of a plurality of programs,
first data associating each program of the plurality of programs with one or more viewers of a plurality of viewers, and
second data associating each viewer of the plurality of viewers with one or more programs of the plurality of programs; and
a file controlling logic portion configured to access at least the data file,
generate a data cluster based on a theme, and
specify a viewer or a program included in the data cluster.

2. The associated-data processor of claim 1, comprising logic for associating inquiry data with a broadcasting signal of a certain program and transmitting the inquiry data.

3. The associated-data processor of claim 1, comprising logic configured to output inquiry data for transmission to the specified viewer.

4. The associated-data processor of claim 3, wherein the inquiry data output by the logic is first or any subsequent inquiry data.

5. The associated-data processor of claim 1, wherein the file controlling logic portion comprises:
transmitter controlling logic configured to, during a broadcasting time slot of a first program or during a certain time slot before or after the broadcasting time slot, output inquiry data associated with one or more items of the basic data related to the first program;
reception controlling logic configured to receive from the viewers, response data associated with the inquiry data;
first logic configured to extract target response data in accordance with first rules from the response data;
second logic configured to extract a target viewer who transmitted the target response data; and
third logic configured to extract:
first identification data of a second program viewed by the target viewer;
second identification data of a new viewer who viewed the second program;
third identification data of the second program comprising third data which is partially common to the basic data related to the first program viewed by the target viewer;
fourth identification data of a new viewer who viewed the second program comprising fourth data which is partially common to the basic data related to the first program viewed by the target viewer; or
combination of the above identification data.

6. The associated-data processor of claim 5, further comprising fourth logic configured to associate first inquiry data with a broadcasting signal of the second program and output the first inquiry data.

7. The associated-data processor of claim 5, further comprising fourth logic configured to output first inquiry data for transmission to the new viewer.

8. The associated-data processor of claim 6, wherein the first inquiry data output by the fourth logic is any inquiry data excluding second inquiry data.

9. The associated-data processor of claim 6, wherein the first inquiry data output by the fourth logic comprises same contents as second inquiry data, or third inquiry data at a next stage.

10. An associated-data processor, in a service server connected to a television receiver by a login operation, comprising a file controlling logic portion comprising:
first logic configured to access a data file constructed by associating a program viewed by a viewer with the viewer based on login data; and
second logic for transmitting the inquiry data related to the program to the viewer who viewed the program by reference to the data file.

11. The associated-data processor of claim 10, wherein the inquiry data is transmitted to a mobile device of the viewer or the television receiver of the viewer via the network.

12. The associated-data processor of claim 11, further comprising:
third logic configured to receive response data to the inquiry data from the viewer via the network;
fourth logic configured to classify the viewer who transmitted the response data depending on a length from a transmission time of the inquiry data until a reply time of the response data; and
fifth logic configured to change contents and/or a transmission time of next inquiry data based on the classified viewer when the next inquiry data is transmitted.

13. An associated-data processing method of an apparatus comprising a data file and a file controlling logic portion, the method comprising:
generating the data file comprising
basic data indicative of attributes related to each program of a plurality of programs,
first data associating each program of the plurality of programs with one or more viewers of a plurality of viewers, and
second data associating each viewer of the plurality of viewers with one or more programs of the plurality of programs;
accessing at least the data file, and generating a data cluster based on a theme; and
specifying a viewer or a program included in the data cluster.

14. The associated-data processing method of claim 13, wherein inquiry data is output in association with a broadcasting signal of the specified program.

15. The associated-data processing method of claim 13, wherein inquiry data is output for transmission to the specified viewer.

16. The associated-data processing method of claim 13, wherein inquiry data is first or any subsequent inquiry data.

17. A non-transitory computer-readable information storage medium comprising instructions, the instructions comprising:
a first instruction for causing a computer to refer to a data file comprising basic data indicative of attributes related to each program of a plurality of programs, first data associating each program of the plurality of programs with one or more viewers, and second data associating each viewer of a plurality of viewers with one or more programs of the plurality of programs;
a second instruction for causing the computer to access at least the data file and generate a data cluster based on a theme; and
a third instruction for causing the computer to specify a viewer or a program included in the data cluster.

18. A non-transitory computer-readable information storage medium comprising instructions the instructions comprising:
a first instruction for causing a computer to refer to a data file in a service server connected to a television receiver by a login operation;
a second instruction for causing the computer to access the data file constructed by associating a program viewed by a viewer with the viewer based on login data; and
a third instruction for, when inquiry data related to the program is transmitted, causing the computer to refer to the data file and transmit the inquiry data to the viewer who viewed the program.
